(19) United States
(12) Patent Application Publication
(10) Pub. No.: US 2021/0186183 A1
(43) Pub. Date: Jun. 24, 2021

(54) APPLICATOR FOR COSMETIC PRODUCT, IN PARTICULAR MASCARA, ASSOCIATED APPLICATOR ASSEMBLY AND METHOD FOR MANUFACTURING SUCH AN APPLICATOR

(71) Applicant: Albea Services, Gennevilliers (FR)

(72) Inventor: Yann Crapet, Gennevilliers (FR)

(21) Appl. No.: 17/133,565

(22) Filed: Dec. 23, 2020

(30) Foreign Application Priority Data
Dec. 23, 2019 (FR) 1915458

(51) Int. Cl. A45D 40/26; A46B 9/02; A46B 9/00; A46D 1/00

(52) U.S. Cl. CPC A45D 40/265; A46B 9/028; A46B 9/005; B33Y 80/00; A46D 1/0253; A46B 2200/1053; A46B 9/021

(57) ABSTRACT

The invention relates to an applicator for cosmetic product. The applicator includes a core that has a first element which is a strand extending along a first longitudinal extension direction of a first end to a second end, and a second element that is at least two strands, extending along at least one second longitudinal extension direction. Only one of the ends of the first element is in material connection with the second element. Further, the strands of the second element delimit a through opening having a first side and a second opposite side, the strand of the first element passing through the opening such that one of the first or second ends extends from one side of the opening and the other of the first or second ends extends from the other side of the opening.

### CROSS REFERENCE TO RELATED APPLICATIONS

This application claims priority under 35 U.S.C. § 119(a) to French patent application number 1915458, filed on Dec. 23, 2019, the entire teachings of which are incorporated herein by reference.

### BACKGROUND OF THE INVENTION

### Field of the Invention

The invention relates to an applicator for cosmetic product, in particular mascara, and an associated applicator assembly. The invention further relates to a method for the manufacturing of such an applicator.

### Description of the Related Art

Mascara applicators can be obtained from fibrous elements held between the longitudinal portions of a twisted metal pin; they are thus commonly called “twisted brushes”. The ends of the fibrous elements usually form envelopes along a longitudinal direction of the brush. The twisted brushes have, by their manufacturing method, a cylindrical-shaped envelope which offers not many possibilities in terms of make-up effects. Numerous solutions have already been proposed to give varied shapes to twisted brushes.

Mascara applicators can also be obtained by injection moulding of plastic material, they are thus commonly called “plastic brushes”. Thus, plastic brushes can have original shapes in order to propose particular make-up effects.

However, there is still a need to improve mascara applicators, in particular to obtain applicators having extended loading zones and/or combing zones.

Another need for improvement is to obtain brushes having several in use configurations and an even greater flexibility.

### BRIEF SUMMARY OF THE INVENTION

The invention relates to an applicator for cosmetic product, including a core, the core including:
a first element including one single strand extending along a first longitudinal extension direction from a first end to a second end, and
a second element including at least two strands, extending along at least one second longitudinal extension direction, wherein only one of the ends of the first element is in material connection with the second element, and the strands of the second element delimit a through opening having a first side and a second opposite side, the strand of the first element passing through the opening such that one of the first or second ends extends from one side of the opening and the other of the first or second ends extends from the other side of the opening.

In other words, the applicator has a core having a single-strand cross-section and a double-strand cross-section which cross one another. This single-strand and double-strand system which cross one another allows to elongate the total length of the core. It is thus possible to obtain a core having a length greater than that of a conventional applicator of which the core only extends from one distal end to a proximal end.

On the one hand, this greater length of the core ensures a better flexibility to the applicator, as well as several in use configurations. On the other hand, the length increases the application surface which may be provided with the cosmetic product and facilitates the arrangement of more extended loading zones and combing zones.

According to different embodiments, which can be taken individually or separately:
the core is made of plastic or synthetic material,
the strands of the second element are connected together so as to form the opening,
the core includes a proximal end capable of being fixed to an applicator rod by a sleeve extending the core,
the core is fixed to the sleeve at the level of the first element,
the core is fixed to the sleeve at the level of the second element,
the first element includes a free end,
at least one of the strand of the second element includes at least one free end,
at least one of the strands is mobile with respect to at least one other strand,
at least one of the strands is mobile with respect to the sleeve,
the first element is mobile with respect to the second element,
the first element is mobile with respect to the sleeve,
at least one of the strands of the second element is mobile with respect to the first element,
at least one of the strands of the second element is mobile with respect to the sleeve,
the core includes at least one abutment means of the at least one mobile strand so as to limit the mobility of the at least one mobile strand,
all or some of the first element includes a plurality of projecting protuberances,
all or some of the second element includes a plurality of projecting protuberances,
the at least one abutment means is at least one protuberance of the first element and/or at least one protuberance of the second element,
at least one protuberance of a strand of the second element is connected to a protuberance of another strand of the second element so as to form an arch between the at least two strands,
the abutment means is at least one of the arches,
the arches define a reservoir volume,
the protuberances are tapered,
the at least one mobile strand is configured to move according an angular movement with respect to the rest of the core,
the applicator has an envelope formed by a distal end of the protuberances,
the envelope has a profile, variable according to the position of the at least one mobile strand,
at least one of the strands follows a line of curvature along its extension direction,
the strand of the first element follows a line of curvature along its extension direction,
at least one of the strands of the second element follows a line of curvature along its extension direction,
all the strands follow a line of curvature along their extension direction,
the line of curvature defines at least one concave portion and at least one convex portion,
the concave portions of each of the strands are directed in the same direction,
the concave portions of each of the strands are directed in opposite directions,
the concave portions are directed towards the inside of the applicator,
the concave portions are directed towards the outside of the applicator,
the line of curvature is a circular arc,
the line of curvature is generally substantially H-shaped,
the applicator is a monolithic part,
the applicator is a part obtained without assembly,
the applicator is a part obtained by additive manufacturing.

The invention also relates to an applicator assembly for cosmetic product, including:
a container including a body forming a reservoir intended to contain the cosmetic product, and
an applicator of the cosmetic product such as described above, adapted to be fixed on the container, such that the applicator is housed inside the reservoir.

The invention finally relates to a method for the manufacturing of an applicator for cosmetic product, in particular mascara, such as described above.

The method includes:
a step of developing a digital model of the applicator;
a step of manufacturing the applicator by means of the digital model.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a cross-sectional view of an example of an applicator assembly according to the invention;

FIG. 2 is a first perspective view of an applicator according to a first embodiment of the invention;

FIG. 3 is another perspective view of the applicator of FIG. 2;

FIG. 4 is a view of a side of the applicator of FIG. 2;

FIG. 5 is a longitudinal cross-section of FIG. 4;

FIG. 6 is a bottom view of the applicator of FIG. 2;

FIG. 7 is a top view of the applicator of FIG. 2;

FIG. 8 is a perspective view of an embodiment variant of the applicator of FIG. 2;

FIG. 9 is a view of a side of an applicator according to a second embodiment of the invention;

FIG. 10 is a view of a side of an applicator according to a third embodiment of the invention;

FIG. 11 is a view of a side of an applicator according to a fourth embodiment of the invention;

FIG. 12 is a view of a side of an applicator according to a fifth embodiment of the invention;

FIG. 13 is a view of a side of an applicator according to a sixth embodiment of the invention;

FIG. 14 is a schematic view of a side of an applicator according to the first embodiment illustrating a position wherein the density of the protuberances is high;

FIG. 15 is a schematic view identical to that of FIG. 14 illustrating a position wherein the density of the protuberances is low.

### DETAILED DESCRIPTION OF THE INVENTION

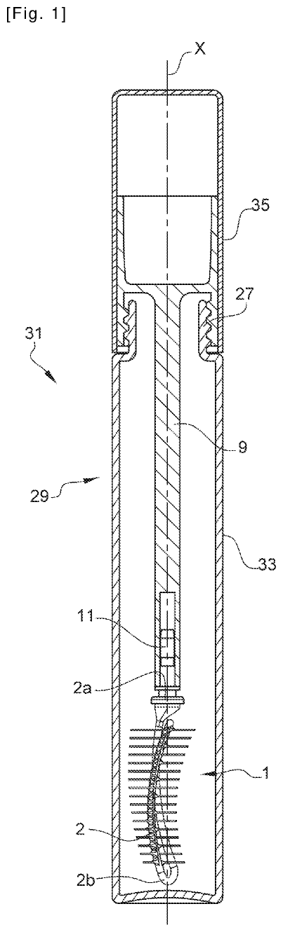

So as to facilitate the understanding of the description, here, in a non-limiting and arbitrary manner, a longitudinal extension direction is defined, called main direction and referenced X in FIG. 1, an upper face, referenced H in the figures, of the applicator and a lower face, referenced B in the figures, of the applicator.

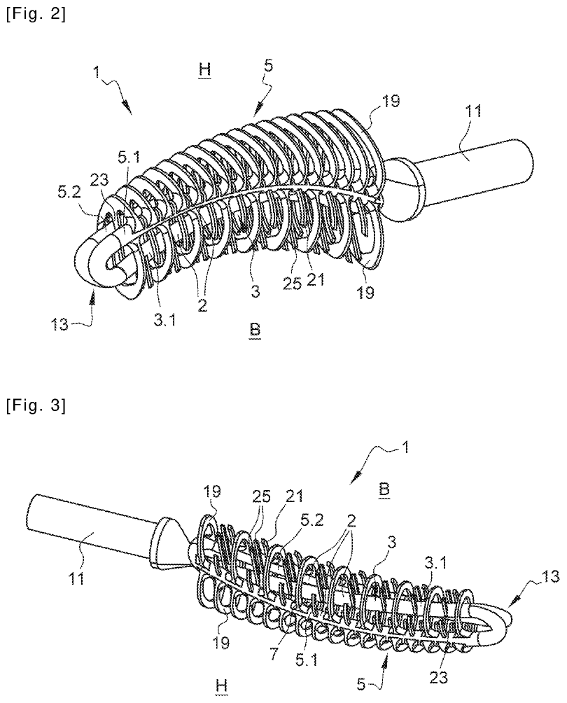

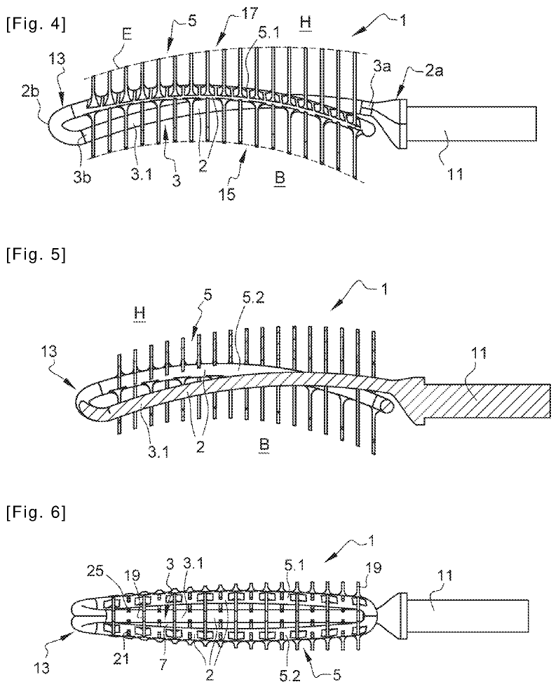

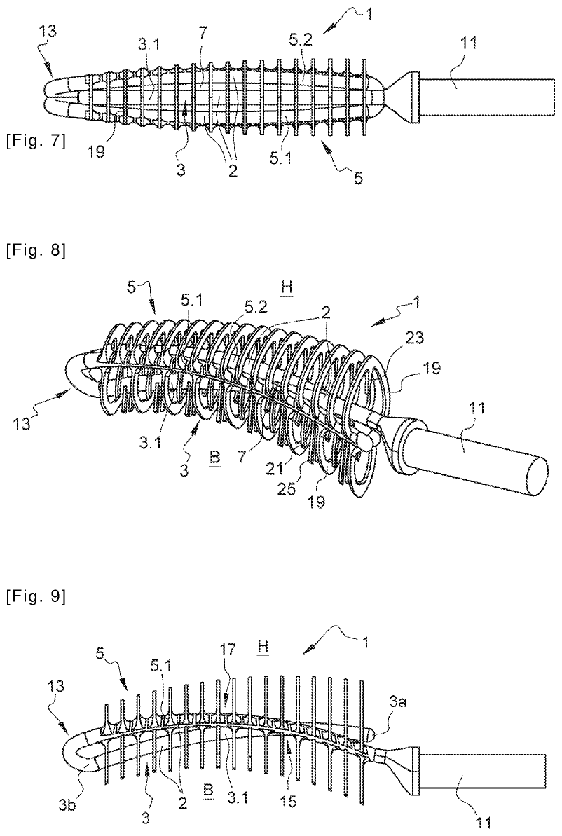

In FIGS. 2 to 5 and 8 to 15, the upper face H is the face directed towards the top and the lower face B is the face directed towards the bottom. The upper face H can be seen in FIG. 6 and the lower face B can be seen in FIG. 7.

In certain embodiments, the upper face H can be considered as in the direction of the outside of the applicator and the lower face B as in the direction of the inside of the applicator.

As illustrated in the different figures, the invention relates to an applicator 1 for cosmetic product, in particular for mascara.

The applicator 1 includes a core 2 including:
a first element 3 including one single strand 3.1 extending along a first longitudinal extension direction from a first end 3a to a second end 3b, and
a second element 5 including at least two strands 5.1, 5.2, extending along at least one second longitudinal extension direction.

Each of the first and second elements 3, 5 is configured to form application zones of the cosmetic product.

According to the invention, only one of the ends 3a, 3b of the first element 3 is in material connection with the second element 5.

The expression “in material connection with” means, here, that a contact, a link exists between the first element 3 and the second element 5. In other words, the first element 3 and the second element 5 are linked together, are in contact.

The connection can be made by a continuity of material, i.e. the first and second elements 3, 5 form one single part in one piece.

The connection can also be made by an applied part connecting the first element 3 to the second element 5. The first element 3 and the second element 5 can be fixed to this applied part by assembly, by gluing, by welding or by any other technique known to a person skilled in the art.

The strands 5.1, 5.2 of the second element 5 delimit a through opening 7 having a first and a second opposite side, the strand 3.1 of the first element 3 passing through the opening 7 such that one of the first or second ends 3a, 3b extends from one side of the opening 7 and the other of the first or second ends 3a, 3b extends from the other side of the opening 7.

Advantageously, the core 2 includes a proximal end 2a capable of being fixed to an applicator rod 9 by a sleeve 11 extending the core 2.

Advantageously, the core 2 is different from a core constituted of two twisted branches.

Advantageously, the core is not obtained by twisting or folding a rod, in particular, a metal rod.

Preferably, the core is made of plastic or synthetic material.

In the applicator 1 of the first embodiment illustrated in FIGS. 2 to 7, the core 2 extends from the sleeve 11 towards a distal end 2b along a first longitudinal extension direction in the form of one single strand 3.1, below called single strand 3.1, corresponding to the first element 3.

At the level of the distal end 2b, the core 2 has a folding 13 towards the top, i.e. in the direction of the upper face H of the applicator 1 and extends along a second longitudinal extension direction in the direction of the sleeve 11 in the form of two strands 5.1, 5.2 corresponding to the second element 5.

Advantageously, in this embodiment, the second element 5 is in continuity of material with the first element 3. The two strands 5.1, 5.2 of the second element 5 are in continuity of material with the single strand 3.1 and form a monolithic part.

The two strands 5.1, 5.2 extend first below the single strand 3.1 at the level of the proximal end 2a of the core then they cross the single strand 3.1 and finally extend above the single strand 3.1 at the level of the sleeve 11.

As can be seen in FIGS. 2, 3, 6 and 7, the two strands 5.1, 5.2 are connected together at the level of the sleeve 11 and thus delimit a through opening 7, through which passes the strand 3.1 of the first element 3.

The opening has a first side directed towards the upper face H and a second opposite side directed towards the lower face B.

In other words, the core 2 is in the form of one single strand 3.1 which extends from the sleeve 11 in the direction of the distal end of the applicator 1 by passing through the opening 7 delimited by the two strands 5.1, 5.2 of the second element 5. The core 2 then continues in the form of the two strands 5.1, 5.2 extending in the direction of the sleeve 11 and delimiting the opening 7 by producing a folding 13 at the level of the distal end of the applicator 1 such that the two strands 5.1, 5.2 pass above the single strand 3.1 up to the crossing between the first element 3 and the second element 5, then below the single strand 3.1 up to the sleeve 11.

In a variant embodiment illustrated in FIG. 8, the opening 7 can have an open end, in other words, the two strands 5.1, 5.2 of the second element 5 are not connected together. The single strand 3.1 however passes through this opening 7, thus allowing the crossing between the single strand 3.1 and the two strands 5.1, 5.2 of the second element 5.

In this embodiment, each of the strands 5.1, 5.2 extends along an identical longitudinal extension direction which corresponds to the longitudinal extension direction of the applicator 1 given by the applicator rod 9, called main direction and referenced X in FIG. 1.

Moreover, each of the strands 3.1, 5.1, 5.2 follows a line of curvature along its extension direction.

The line of curvature is, here, a circular arc which defines, for each strand 3.1, 5.1, 5.2, a concave portion and a convex portion.

In this embodiment, the three strands 3.1, 5.1, 5.2 follow an identical curvature, however with an offset of the line of curvature of the single strand 3.1 such that the line of curvature of the single strand 3.1 crosses the line of curvature of the two strands 5.1, 5.2 of the second element 5. This allows the passage of the single strand 3.1 into the opening 7 formed by the two strands 5.1, 5.2 of the second element 5.

With the lines of curvature being identical, the concave portions, respectively convex, of each of the strands 3.1, 5.1, 5.2 are directed in the same direction, thus forming a convex zone 17 directed towards the upper face H of the applicator 1, i.e. towards the outside of the applicator 1, and a concave zone 15 directed towards the lower face B of the applicator 1, i.e. towards the inside of the applicator 1.

In other variant embodiments not represented, it is possible that each of the strands 3.1, 5.1, 5.2 follow their own curvature. The concave and convex portions can thus be directed in opposite directions or in the same direction. It is also possible that one or more strands 3.1, 5.1, 5.2 is/are rectilinear. It can also be considered that the line of curvature is more complex, S-shaped, for example. The line of curvature thus defines at least one concave portion and at least one convex portion.

Advantageously, the concave zone 15 forms a reservoir volume for the cosmetic product.

As illustrated in the embodiments represented here, the core 2 can include protuberances 19, 21, 23, 25.

In the embodiments illustrated, the two strands 5.1, 5.2 of the second element 5 include protuberances 19, 21, 23 directed in the direction of the upper face H and protuberances directed 19, 21 in the direction of the lower face B of the applicator 1. The protuberances are in the form of arches 19 and tapered protuberances 21.

Each arch 19 is formed by a protuberance of a strand 5.1, 5.2 of the second element 5 which is connected to a protuberance of another strand 5.1, 5.2 of the second element 5, the protuberances projecting in the direction of one same face of the applicator 1. Each of the upper and lower faces H, B of the applicator 1 includes arches 19. Thus, each arch 19 connects the two strands 5.1, 5.2 of the second element 5 so as to form a type of cage around the applicator 1, and around the single strand 3.1. Advantageously, the arches 19 define a reservoir volume for the cosmetic product.

The arches 19 of the upper face H further include an additional tapered protuberance 23 and extending from the centre of the arch 19 and projecting towards the bottom in the direction of the single strand 3.1.

Each of the two strands 5.1, 5.2 of the second element 5 also includes tapered protuberances 21 projecting in the direction of the lower face B. The tapered protuberances 21 are positioned between the arches 19 projecting in the direction of the lower face B. They are also aligned with arches 19 projecting in the direction of the upper face H.

In this first embodiment, the single strand 3.1 also includes protuberances 25. These are tapered protuberances 25 projecting in the direction of the lower face B. They are arranged in pairs and aligned axially with the tapered protuberances 21 of the two strands 5.1, 5.2 of the second element 5. These protuberances 25 thus form two longitudinal rows.

Preferably, the free end of the tapered protuberances 21, 25, as well as the distal end of the arches 19 form an envelope E of which an outer surface has particular shapes described below.

In the first embodiment, the protuberances 21 and the arches 19 of the two strands 5.1, 5.2 of the second element 5 projecting towards the lower face B have one same maximum height and the protuberances 25 of the single strand 3.1 projecting towards the lower face B have a variable height such that the lower portion B of the envelope E has an outer surface which follows the line of curvature of the two strands 5.1, 5.2 of the second element 5, i.e. a concave curvature.

The arches 19 of the two strands 5.1, 5.2 of the second element 5 projecting towards the upper face H have a variable height such that the upper portion of the envelope has an ogive-shaped outer surface, i.e. a convex line of curvature.

The ogive shape facilitates, in particular, the insertion of the applicator 1 through a neck 27 of a container 29 containing the cosmetic product and the application of the cosmetic product at the level of the inner corner of the eye.

Thus, the outer envelope has, on a (lower) side, a cylindrical shape of which the wall has a concave line of curvature and on another (upper) side, an ogive shape of convex line of curvature.

Other casing shapes can be considered, in particular those which are described below.

Advantageously, the core 2 has a free end.

In the first embodiment, the single strand 3.1 is, at an end 3a, connected with the sleeve 11 and, at the other end 3b, connected with the second element 5. The two strands 5.1, 5.2 of the second element 5 are connected together at the level of the sleeve 11, but are not in material connection with the sleeve 11 neither with the first element 3 at the level of the sleeve 11. The second element 5 thus includes a free end, which is here a proximal end, close to the sleeve 11.

This freedom allows, in particular, the second element 5 to be mobile with respect to the first element 3 and with respect to the sleeve 11. Thus, in this first embodiment, the second element 5 can be moved, in particular according an angular deflection, without the first element 3 being moved. This allows a modification of the general shape of the envelope E, in particular, a variation of the density of the protuberances 19, 21, 25.

This flexibility and this mobility of the free strand allows to make the general shape of the envelope E of the applicator 1 vary notably, as can be seen in FIGS. 14 and 15.

Thus, in certain embodiments, the flexibility allows to have a loading function. In this position, the envelope E has a high protuberance density which favours the cosmetic product loading. This is, in particular, illustrated in FIG. 14.

In at least one other second position, the flexibility allows to have in at least one position, a comb function. The envelope E has protuberances which emerge from the general envelope E thus decreasing the density of protuberances and thus favouring the styling. This is in particular illustrated in FIG. 15.

In this first embodiment, the slim shape of the single strand 3.1 also allows a mobility of the first element 3 with respect to the sleeve 11. A movement of the single strand 3.1 however also leads to a movement of the second element 5.

The flexibility of the first 3 and/or second 5 elements also advantageously allows to modify the line of curvature of the strands 3.1, 5.1, 5.2. A strand 3.1, 5.1, 5.2 can thus pass from a curved shape to a rectilinear shape or conversely, to a more or less curved shape.

This flexibility of the core 2 allows to diversify the make-up possibilities and to obtain a greater range of make-up effects with one single applicator 1.

Advantageously, the core 2 includes at least one means for abutting the at least one mobile strand so as to limit its mobility.

In this first embodiment, the additional protuberance 23 of the arches 19 of the upper face H serves as an abutment to the second element 5 when this is displaced towards the bottom. Indeed, the additional protuberances 23 abut on the single strand 3.1, blocking the movement of the second element 5.

When the second element 5 is moved towards the top, it abuts with the single strand 3.1 at the junction of its two strands 5.1, 5.2. This junction thus advantageously serves as an abutment means.

In other embodiments not represented, the arches 19 can serve as an abutment means when they come into contact with the single strand 3.1 thus blocking the movement of the mobile strand, in particular when the embodiment does not include any additional protuberance 23 at the level of the arches 19 or also in an embodiment like that of FIG. 8 wherein the two strands 5.1, 5.2 do not join one another.

The applicator 1 according to the second embodiment illustrated in FIG. 9 differs from the applicator 1 of the first embodiment by the location of the fixing of the core 2 to the sleeve 11. In this second embodiment, the core 2 is fixed to the sleeve 11 by the second element 5.

In this second embodiment, the single strand 3.1 has a free end at the level of its proximal end 3a at the level of the sleeve 11. This single strand 3.1 is thus mobile with respect to the sleeve 11 and with respect to the second element 5.

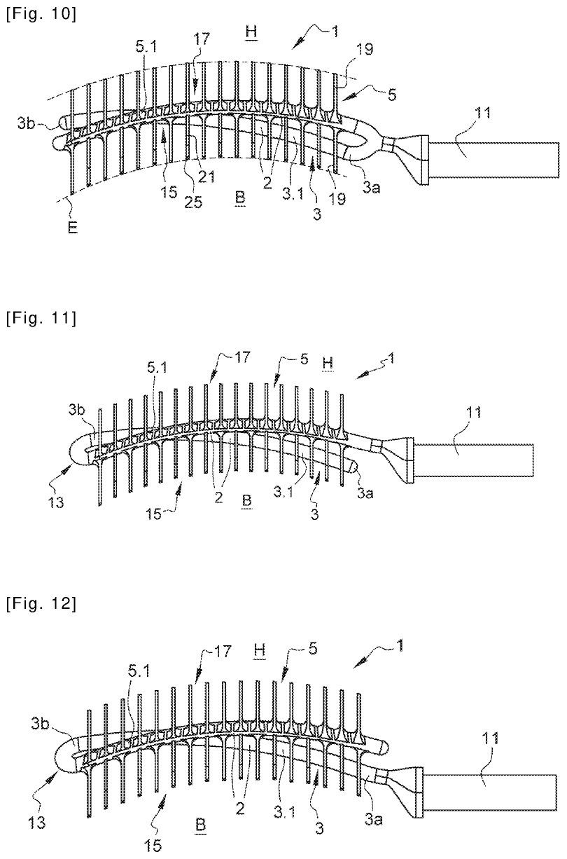

The applicator 1 according to the third embodiment illustrated in FIG. 10 differs from the applicator 1 of the first and of the second embodiment by the location of the fixing of the core 2 to the sleeve 11. In this third embodiment, the core 2 is fixed to the sleeve 11 at the level of the connection between the first element and the second element 5.

In this third embodiment, the single strand 3.1 and the second element 5 each have a free end. These ends are all situated at the level of the distal end of the applicator 1, opposite the sleeve 11.

In this third embodiment, the single strand 3.1 and the second element 5 are each mobile with respect to the sleeve 11, and mobile independently from one another. The single strand 3.1 can be displaced in a direction (towards the top or towards the bottom) and the second element 5 in another opposite direction. The single strand 3.1 and the second element 5 can also be displaced in one same direction. The single strand 3.1 can also be displaced without the second element 5 being displaced, and conversely.

In this third embodiment, the general shape of the envelope E also differs with respect to the envelope E of the first and second embodiments. Indeed, the applicator 1 has a general cylindrical shape which follows the curvature of the first element 3. All the arches 19 of one same face have a similar height.

The applicator 1 according to the fourth embodiment illustrated in FIG. 11 differs from the applicator 1 of the second embodiment by the arrangement of the first element 3 with respect to the second element 5, in other words, by the direction of the folding 13 of the core 2.

In this fourth embodiment, the core 2 is also fixed to the sleeve 11 at the level of the second element 5, but the folding 13 of the core 2 is done towards the top. The free end of the single strand 3.1 is still the proximal end 3a which is situated at the level of the sleeve 11. The proximal end 3a of the first element is located below the second element 5.

In this fourth embodiment, the general shape of the envelope E also differs with respect to the envelope E of the first and second embodiments. It is similar to that of the embodiments of FIGS. 10 and 12. The applicator 1 has a general cylindrical shape which follows the curvature of the first element 3.

The applicator 1 according to the fifth embodiment illustrated in FIG. 12 differs from the applicator 1 of the first embodiment by the arrangement of the first element 3 with respect to the second element 5, in other words by the direction of the folding 13 of the core 2.

In this fifth embodiment, the core 2 is also fixed to the sleeve 11 at the level of the first element 3, but the folding 13 of the core 2 is done towards the top. The free end of the second element 5 is situated at the level of the sleeve 11 and is thus above the single strand 3.1.

In this fifth embodiment, the general shape of the envelope E also differs with respect to the envelope E of the first and second embodiments. It is similar to that of the embodiments of FIGS. 10 and 11. The applicator 1 has a general cylindrical shape which follows the curvature of the first element 3.

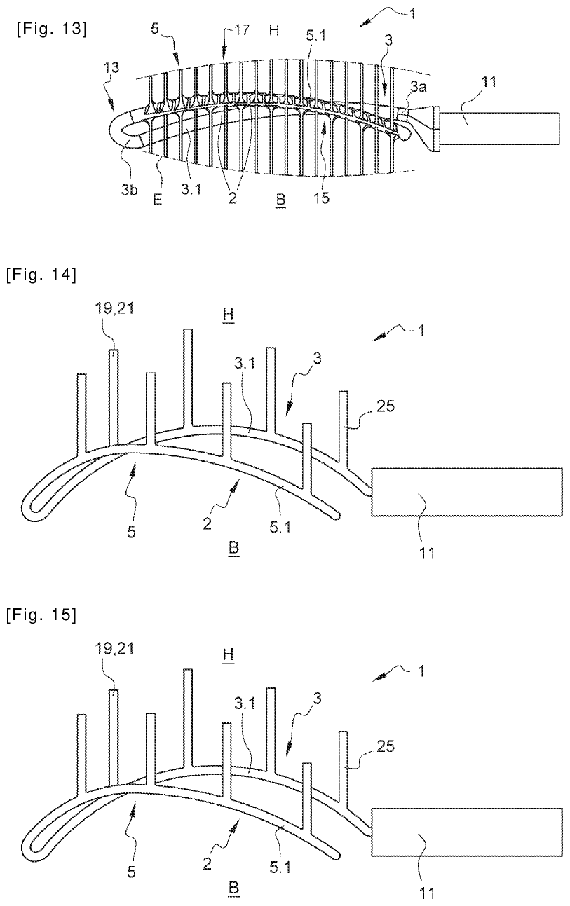

The applicator 1 according to the sixth embodiment illustrated in FIG. 13, is similar to the first embodiment. Only the general shape of the envelope E formed by the free end of the protuberances differs.

The protuberances projecting from the two strands 5.1, 5.2 of the second element 5 are of variable height. The shape of the envelope E therefore no longer follows the curvature of these two strands 5.1, 5.2, but has a general ogive shape at the level of the distal end of the applicator 1.

Advantageously, the applicator 1 is one single monolithic part obtained without assembly. In other words, the applicator 1 is not obtained by assembly.

“Assembly” is understood here as the action of putting together, assembling at least two isolated elements, but does not exclude the possibility of several steps.

It must be noted also that the applicator 1 advantageously forms a brush.

Preferably, the applicator 1 described above is obtained by an additive manufacturing method.

By additive manufacturing method, this means a method for manufacturing by adding material, generally computer-assisted. Such a manufacturing method is also called three-dimensional printing or also 3D printing.

Advantageously, the use of three-dimensional printing can allow to carry out, in one single step, an applicator 1 made of one single part and in continuity of material including a core 2 composed of strands 3.1, 5.1, 5.2 which cross one another. Such an applicator 1 could prove to be very complex, even impossible to obtain, in particular made of one single part, by a conventional injection moulding method. It is thus possible to produce, directly and by one single manufacturing operation, the applicator 1. In addition, this technique allows to avoid the use of complex moulds.

It can also be considered, in a variant embodiment, that three-dimensional printing is used to form the core 2 with the sleeve 11 and/or the rod 9.

Different additive manufacturing technologies known to a person skilled in the art can be used. In particular, it can be:
fused deposition modelling (FDM),
selective laser melting (SLM),
selective laser sintering (SLS),
electron beam melting (EBM),
stereolithography apparatus (SLA), or
laminated object manufacturing (LOM).

Preferably, these are sintering and/or stereolithography technologies.

The invention also relates to a method for manufacturing an applicator 1 such as described above. The method includes:
a step of developing a digital model of the applicator 1;
a step of manufacturing the applicator 1 by means of the digital model.

The digital model is a computerised file which corresponds to a virtual model of the applicator 1. To obtain it, the applicator 1 is first modelled so as to obtain a CAD model which is then converted into a suitable format such as an .STL file. The file is then utilised on an additive manufacturing machine. During its reading, the digital model is cut into a certain number of layers according to the desired precision. Preferably, the layers correspond to a transversal cross-section of the applicator 1, i.e. a cross-section of the applicator 1 taken in a plane perpendicular to the main direction X.

Suitable materials for manufacturing the applicator 1 by a three-dimensional printing are polyamides, photosensitive resins, polylactic acid (PLA), acrylonitrile butadiene styrene (ABS), polypropylene (PP).

The invention also relates to an applicator assembly 31 for cosmetic product, including the container 29 including a body 33 forming a reservoir intended to contain the cosmetic product (not represented), and an applicator 1, such as described above, adapted to be fixed on the container 29, such that the applicator 1 is housed inside the reservoir. The applicator 1 is fixed, for example, to a proximal end of the rod 9, itself fixed to a plug 35, advantageously screwed to the container 29.

Advantageously, the applicator assembly 31 can be totally or partially obtained by three-dimensional printing. Of note, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, and/or “including,” when used in this specification, specify the presence of stated features, integers, steps, operations, elements, and/or components, but do not preclude the presence or addition of one or more other features, integers, steps, operations, elements, components, and/or groups thereof.

As well, the corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

1. An applicator for a cosmetic product, comprising a core, the core comprising:
a first element comprising one single strand extending along a first longitudinal extension direction from a first end to a second end, and
a second element comprising at least two strands, extending along at least one second longitudinal extension direction,
wherein only one of the ends of the first element is in material connection with the second element, and
wherein the strands of the second element delimit a through opening having a first side and a second opposite side, the strand of the first element passing through said opening such that one of the first or second ends extends from one side of the opening and the other of the first or second ends extends from the other side of the opening.

2. The applicator according to claim 1, wherein the core is made of plastic or synthetic material.

3. The applicator according claim 1, wherein the core comprises a proximal end capable of being fixed to an applicator rod by a sleeve extending the core, the core is fixed to the sleeve at the level of the first element or at the level of the second element.

4. The applicator according to claim 1, wherein at least one of the strands is mobile with respect to at least one other strand and/or with respect to the sleeve.

5. The applicator according to claim 4, wherein the core comprises at least one means for abutting the at least one mobile strand, so as to limit the mobility of the at least one mobile strand.

6. The applicator according to claim 1, wherein all or some of the first element comprises a plurality of projecting protuberances and/or all or some of the second element comprises a plurality of projecting protuberances.

7. The applicator according to claim 6, wherein at least one protuberance of a strand of the second element is connected to a protuberance of another strand of the second element so as to form an arch between the at least two strands, the abutment means being at least one of the arches.

8. The applicator according to claim 6, having an envelope formed by a distal end of the protuberances, said envelope having a variable profile according to the position of the at least one mobile strand.

9. The applicator according to claim 1, wherein at least one of the strands follows a line of curvature along its extension direction.

10. The applicator according to claim 1, wherein the applicator is a monolithic part obtained without assembly and by additive manufacturing.

11. An applicator assembly for cosmetic product, comprising:
a container comprising a body forming a reservoir intended to contain the cosmetic product, and
an applicator of the cosmetic product comprising a first element comprising one single strand extending along a first longitudinal extension direction from a first end to a second end, and a second element comprising at least two strands, extending along at least one second longitudinal extension direction, wherein only one of the ends of the first element is in material connection with the second element, and wherein the strands of the second element delimit a through opening having a first side and a second opposite side, the strand of the first element passing through said opening such that one of the first or second ends extends from one side of the opening and the other of the first or second ends extends from the other side of the opening,
wherein the applicator is adapted to be fixed on the container, such that the applicator is housed inside the reservoir.

12. A method for manufacturing an applicator for cosmetic product comprising comprising a first element comprising one single strand extending along a first longitudinal extension direction from a first end to a second end, and a second element comprising at least two strands, extending along at least one second longitudinal extension direction, wherein only one of the ends of the first element is in material connection with the second element, and wherein the strands of the second element delimit a through opening having a first side and a second opposite side, the strand of the first element passing through said opening such that one of the first or second ends extends from one side of the opening and the other of the first or second ends extends from the other side of the opening, the method comprising:
developing a digital model of the applicator; and,
manufacturing the applicator by means of the digital model.
